(19) United States
(12) Patent Application Publication
(10) Pub. No.: US 2025/0051139 A1
(43) Pub. Date: Feb. 13, 2025

(54) ARRANGEMENT FOR REPLACING ELEVATOR SUSPENSION ROPES AND A METHOD

(71) Applicant: Kone Corporation, Helsinki (FI)

(72) Inventors: Juha HELENIUS, Helsinki (FI); Hannu ÄIKÄS, Helsinki (FI); Aki LAAKKONEN, Helsinki (FI)

(73) Assignee: Kone Corporation, Helsinki (FI)

(21) Appl. No.: 18/933,012

(22) Filed: Oct. 31, 2024

Related U.S. Application Data
(63) Continuation of application No. PCT/EP2022/064922, filed on Jun. 1, 2022.

(51) Int. Cl. B66B 19/02; B66B 11/08; B66B 17/12

(52) U.S. Cl. CPC B66B 19/02; B66B 11/08; B66B 17/12

(57) ABSTRACT

An arrangement for replacing an elevator suspension rope comprises an elevator shaft; and an elevator with a car, a hoisting machinery, one or more suspension ropes, and a counterweight; the car and the counterweight being suspended by said one or more ropes which are adapted to be guided over a traction sheave comprised by the machinery for moving the car along the elevator shaft; wherein the car and the counterweight are arranged at any vertical height in the shaft when replacing said one or more ropes. A method for replacing an elevator suspension rope in said arrangement.

### CROSS-REFERENCE TO RELATED APPLICATION

This application is a continuation of PCT International Application No. PCT/EP2022/064922 which has an International filing date of Jun. 1, 2022, the entire contents of which are incorporated herein by reference.

### FIELD OF THE INVENTION

The invention relates to replacing suspension ropes of an elevator. The elevator is preferably an elevator for transporting passengers and/or goods.

### BACKGROUND OF THE INVENTION

For various reasons it might become necessary to replace one or more suspension ropes in an elevator.

Reasons for rope replacement may include rope damage e.g. due to manufacturing error, mishandling during installation or maintenance, rope hitting shaft equipment or object between rope and pulley.

Known methods may be time consuming and inefficient. Practical experience in high rise buildings have shown that most of the total time required for rope replacement is spent on preparations-especially pit preparations such as building the scaffold, protecting the compensation ropes, and lifting the compensator take a lot of time. It may take 4-5 working days to prepare the elevator for rope replacement and return it back to service. By contrast, the rope replacement work itself may take only 2 hours. Depending on the elevator and the number of ropes to be replaced, the time spent on rope replacement work itself can be only 5-10% of the total time of the operation. The time required for the whole operation may be so long that the elevator has to be taken out of service for several days, which causes difficulties and financial losses for the customer. Elevator downtime also causes disadvantages to passengers.

### SUMMARY OF THE INVENTION

An object of the present invention is to present an improved arrangement and method for replacing suspension ropes of an elevator.

It is brought forward a new arrangement for replacing an elevator suspension rope, the arrangement comprising an elevator shaft; and an elevator with a car, a hoisting machinery, one or more suspension ropes, and a counterweight; the car and the counterweight being suspended by said one or more ropes which are adapted to be guided over a traction sheave comprised by the machinery for moving the car along the elevator shaft. The car and the counterweight are arranged at any vertical height in the shaft when replacing said one or more ropes.

Preferable further details of the invention are introduced in the following, which further details can be combined individually or in any combination.

In a preferred embodiment, the car is arranged to be movable during the rope replacement.

In a preferred embodiment, the one or more ropes are adapted to be released one rope at a time.

In a preferred embodiment, the arrangement comprises at least one reel for new rope arranged on a topmost landing of the shaft or on the car roof or inside the car for new rope delivering.

In a preferred embodiment, the arrangement comprises a cutter or at least one reel for old rope arranged on a bottommost landing of the shaft for old rope treatment.

In a preferred embodiment, cut outs in the path of the rope to be replaced are arranged to be protected or covered.

In a preferred embodiment, the arrangement comprises tools for holding and elongating the rope during removing and installing the rope, said tools comprising a hoist and a rope gripper to be installed between one suspension rope and the car.

In a preferred embodiment, the arrangement comprises a rope reeling device with a friction roller arranged in connection with the machinery for forming a tool for moving the rope to be replaced.

In a preferred embodiment, friction reduction rollers are arranged in connection with the traction sheave for forming a tool for friction reduction.

In a preferred embodiment, a twist stopper tool is placed in the path of the rope.

In a preferred embodiment, a rope guidance tool is arranged on the topmost landing of the shaft for guiding the ropes.

In a preferred embodiment, a rope guidance tool is arranged on the bottommost landing of the shaft for guiding the ropes.

In a preferred embodiment, a rope storage unit with at least one rope reel is arranged on the topmost landing of the shaft for storing and reeling the ropes.

In a preferred embodiment, a rope storage unit with at least one rope reel is arranged on the bottommost landing of the shaft for storing and reeling the ropes.

In a preferred embodiment, the car is arranged to be moved using inspection drive at any stage of the rope replacement.

In a preferred embodiment, an end of the old rope is adapted to be taken from the counterweight to the bottommost landing of the shaft and the new rope is adapted to be moved from the landing to the counterweight without visiting the shaft.

In a preferred embodiment, the one or more ropes are adapted to be replaced one rope at a time.

In a preferred embodiment, one or more ropes are simultaneously adapted to be released at the car end.

In a preferred embodiment, a low friction coating is adapted to be applied on the traction sheave. In a preferred embodiment, a low friction coating is adapted to be applied on the diverting pulley.

In a preferred embodiment, a rope terminal at the car end is adapted to be removed when the car is in halfway position in the shaft.

In a preferred embodiment, a counterweight rope terminal is adapted to be removed when the car is in a position in the shaft that allows access to the counterweight rope terminals from a roof of the car.

In a preferred embodiment, the car is adapted to be moved to the topmost landing in the shaft for joining old and new ropes.

In a preferred embodiment, the new rope is adapted to be connected end to end to the old rope with a mesh grip.

In a preferred embodiment, the old rope is adapted to be guided to the bottommost landing of the shaft, and simultaneously the new rope is adapted to be fed from the topmost landing.

In a preferred embodiment, a counterweight rope terminal is adapted to be secured to the counterweight when the car is in a position in the shaft that allows access to the counterweight rope terminals from a roof of the car.

In a preferred embodiment, a rope terminal at car end is adapted to be secured in place when the car is in a bottom position in the shaft.

In a preferred embodiment, the rope to be replaced comprises a load-bearing part made of a composite material, said composite material comprising reinforcing fibers, which consist of carbon fiber or glass fiber, in a polymer matrix.

It is also brought forward a new method for replacing an elevator suspension rope in any arrangement as described above, comprising arranging the car and the counterweight at any vertical height in the shaft when replacing said one or more ropes.

Preferable further details of the invention are introduced in the following, which further details can be combined individually or in any combination.

In a preferred embodiment, the method comprises arranging the car movable during the rope replacement.

In a preferred embodiment, the method comprises releasing the one or more suspension ropes one rope at a time.

In a preferred embodiment, the method comprises arranging at least one reel for new rope on a topmost landing of the shaft or on the car roof or inside the car for new rope delivering.

In a preferred embodiment, the method comprises arranging a cutter on a bottommost landing of the shaft for old rope treatment. In a preferred embodiment, the method comprises arranging at least one reel for old rope on a bottommost landing of the shaft for old rope treatment.

In a preferred embodiment, the method comprises protecting or covering cut outs in the path of the rope to be replaced.

In a preferred embodiment, the method comprises holding and elongating the rope during removing and installing by a hoist and a rope gripper installed between one suspension rope and the car.

In a preferred embodiment, the method comprises moving the rope to be replaced by a rope reeling device with a friction roller in connection with the machinery.

In a preferred embodiment, the method comprises reducing friction by friction reduction rollers arranged in connection with the traction sheave.

In a preferred embodiment, the method comprises placing a twist stopper tool in the path of the rope.

In a preferred embodiment, the method comprises guiding the ropes by a rope guidance tool which is arranged on the topmost landing of the shaft. In a preferred embodiment, the method comprises guiding the ropes by a rope guidance tool which is arranged on the bottommost landing of the shaft.

In a preferred embodiment, the method comprises storing and reeling the ropes by a rope storage unit with at least one rope reel arranged on the topmost landing of the shaft. In a preferred embodiment, the method comprises storing and reeling the ropes by a rope storage unit with at least one rope reel arranged on the bottommost landing of the shaft.

In a preferred embodiment, the method comprises moving the car using inspection drive at any stage of the rope replacement.

In a preferred embodiment, the method comprises taking an end of the old rope from the counterweight to the bottommost landing and/or moving the new rope from the landing to the counterweight without visiting the shaft.

In a preferred embodiment, the method comprises replacing the one or more suspension ropes one rope at a time.

In a preferred embodiment, the method comprises applying a low friction coating on the traction sheave. In a preferred embodiment, the method comprises applying a low friction coating on the diverting pulley.

In a preferred embodiment, the method comprises removing a rope terminal at the car end when the car is in halfway position in the shaft.

In a preferred embodiment, the method comprises removing a counterweight rope terminal when the car is in a position in the shaft that allows access to the counterweight rope terminals from a roof of the car.

In a preferred embodiment, the method comprises moving the car to the topmost landing in the shaft for joining old and new ropes.

In a preferred embodiment, the method comprises connecting the new rope end to end to the old rope with a mesh grip.

In a preferred embodiment, the method comprises guiding the old rope to the bottommost landing of the shaft, and simultaneously feeding the new rope from the topmost landing.

In a preferred embodiment, the method comprises securing a counterweight rope terminal to the counterweight when the car is in a position in the shaft that allows access to the counterweight rope terminals from a roof of the car.

In a preferred embodiment, the method comprises securing a rope terminal at car end in place when the car is in a bottom position in the shaft. The method and the arrangement described enhance safety in the replacement process since the elevator car can be moved using inspection drive at any stage of the replacement method.

The rope replacement can be done from car top when the car and the counterweight are in the middle of the shaft. The work done in the pit such as protecting compensation ropes, building the scaffold, lifting the compensator can be left out which saves a lot of time.

The new method and arrangement are suitable for replacing one or more suspension ropes.

Omitting majority of preparations such as work done in the pit enables fast rope replacement which could be done during night-time to minimize elevator downtime and disadvantages for passengers and customer.

The new method and arrangement aim to reduce significantly the time needed for rope replacement in comparison to the current situation.

The new method and arrangement allow for quick replacement of suspension ropes, as no massive preparations are needed.

### BRIEF DESCRIPTION OF THE DRAWINGS

The invention will in the following be described in greater detail by means of preferred embodiments with reference to the attached drawings, in which:

FIG. 1 shows an arrangement for an elevator suspension rope replacement,

FIG. 2 shows a rope storage unit with three rope reels,

FIG. 3 shows a tool for stopping twist of the rope,

FIG. 4 shows a tool for friction reduction,

FIG. 5 shows a tool for reeling the rope,

FIG. 6 shows a tool for guiding the rope,

FIG. 7 shows tools for holding and elongating the rope during removing and installing,

FIGS. 8 to 17 show example phases of the elevator suspension rope replacement, and

FIG. 18 shows example phases of the elevator suspension rope replacement in a flow chart.

### DETAILED DESCRIPTION

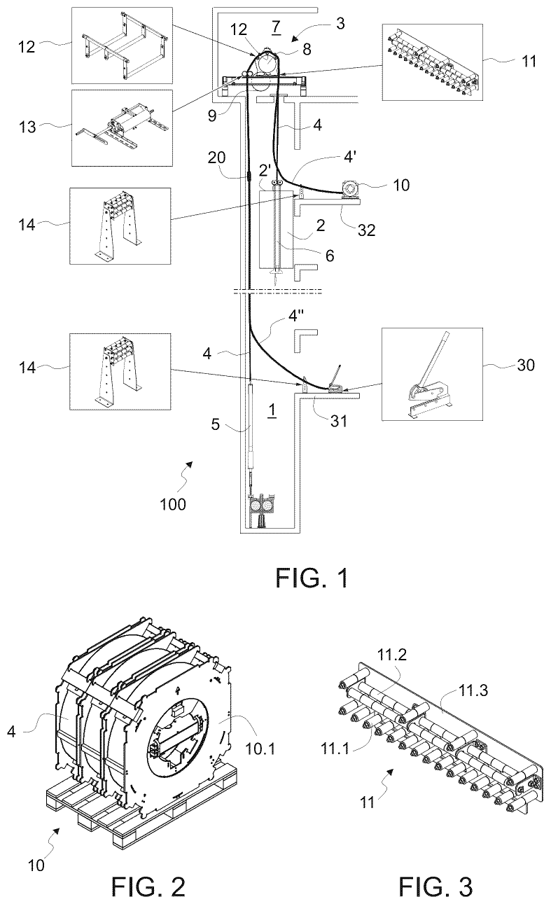

FIG. 1 shows a side view of the arrangement 100 for replacing an elevator suspension rope 4, the arrangement comprising an elevator shaft 1 and an elevator.

The elevator may comprise an elevator shaft 1, a car 2, a hoisting machinery 3, suspension ropes 4, and a counterweight 5. A separate or an integrated car frame 6 may surround the car 2. The car and the counterweight are suspended by one or more ropes 4. The ropes 4 are adapted to be guided over a traction sheave 8. The car may be moved along the shaft 1 when rotating the traction sheave.

The replacement of one or more ropes 4 can be carried out without the parking process of the car 2 in the shaft 1. The car 2 is arranged to be movable during the rope replacement.

The car 2 and the counterweight 5 can be at any vertical height in the shaft 1 when replacing the one or more ropes 4.

The car 2 may be moved using inspection drive at any stage of the rope replacement.

The hoisting machinery 3 may be positioned in a machine room 7 above the shaft 1 or in the shaft. The hoisting machinery may comprise a drive, an electric motor, the traction sheave 8, a diverting pulley 9 and a machinery brake. The hoisting machinery 3 may move the car 2 in a vertical direction upwards and downwards in the vertically extending elevator shaft 1. The machinery brake may stop the rotation of the traction sheave 8 and thereby the movement of the elevator car 2.

During the suspension rope replacement task, one technician may work in the machine room 7 as the other may work on a car roof 2′. A cutter 30 for old ropes 4″ or at least one old rope 4″ reel may be arranged on the bottommost landing 31 of the shaft 1 for old rope treatment. At least one new rope 4′ reel 10 may be arranged on the topmost landing 32 for new rope 4′ delivering. Work phases may be planned and scheduled so that the tools and parts are not used or moved in the machine room 7 when the technician is on the car roof 2′. Cut outs, such as sharp edges, in the path of the rope to be replaced, such as in the machine room 7, are arranged to be protected or covered so that the ropes do not get damaged. Risk of the objects falling from the machine room 7 to the elevator shaft 1 may be eliminated.

Tasks of the technician in the machine room 7 may include: controlling and leading the work; preparing and finalizing the machinery 3; guiding and reeling suspension ropes 4′ and 4″ over the traction sheave 8 and the diverting pulley 9; and monitoring rope twist and tangling when the elevator car 2 is moved, optionally using a twist stopper tool 11 and/or friction reduction rollers 12.

Tasks of the technician on the car roof 2′ may include: removing suspension ropes 4″ and installing suspension ropes 4′ to rope terminals 19 and hitch plates; assisting the technician in the machine room 7 with a rope reeling device 13 installation and removal, if required; and operating new rope 4′ reel 10 during rope reeling.

Tasks of the technician on the landing 31 with cutter 30 may include: reeling onto a reel 10 or cutting with the cutter 30 the old suspension rope 4″; and guiding the old rope 4″ end to the landing 31 and new rope 4′ end to the counterweight 5.

The end of the old rope 4″ may be taken from the counterweight 5 to the landing 31 and the new rope 4′ moved from the landing 31 to the counterweight 5 without visiting the shaft 1. This can be done using a catcher tool equipped with a pole which may be telescopic. The rope or a wire 22 (shown in FIGS. 11, 12 and 14) attached to the rope or a counterweight rope terminal may be catched by a catching member at an end of the pole. The old rope 4″ with the rope terminal may be moved to the landing 31 and the new rope 4′ end without the rope terminal may be moved from the landing 31, particularly by the technician working on the landing 31.

The old rope 4″ and the new rope 4′ may be attached temporarily in connection with the counterweight 5 for example by magnets. A rope guidance tool 14 may be used when guiding the ropes 4 on the topmost landing 32 and on the bottommost landing 31, preferably before the cutter 30.

FIG. 2 illustrates an embodiment of a rope storage unit on a transport pallet for storing and reeling elevator ropes 4. The rope storage unit in FIG. 2 comprises three rope reels 10, formed by a rope 4 wound in a spiral form; and a support frame 10.1 provided with an inner space inside which the rope reel 10 is positioned supported by the support frame 10.1 such that it can in use be rotated in the inner space for unwinding the rope 4.

FIG. 3 illustrates the twist stopper tool 11 in more detail. The twist stopper tool 11 may be placed in the path of the rope, preferably in the machine room 7, particularly on a machinery 3 bed plate on car 2 side of the traction sheave 8, and secured with clamps.

In an example installed position, the twist stopper tool 11 comprises horizontal first rollers 11.1 and horizontal second rollers 11.2 secured rotatably relative a base plate 11.3. The rotational axes of the first rollers 11.1 extend horizontally from the base plate 11.3. The rotational axes of the second rollers 11.2 are aligned and parallel with the base plate 11.3. The rotational axes of the first and second rollers are perpendicular to each other.

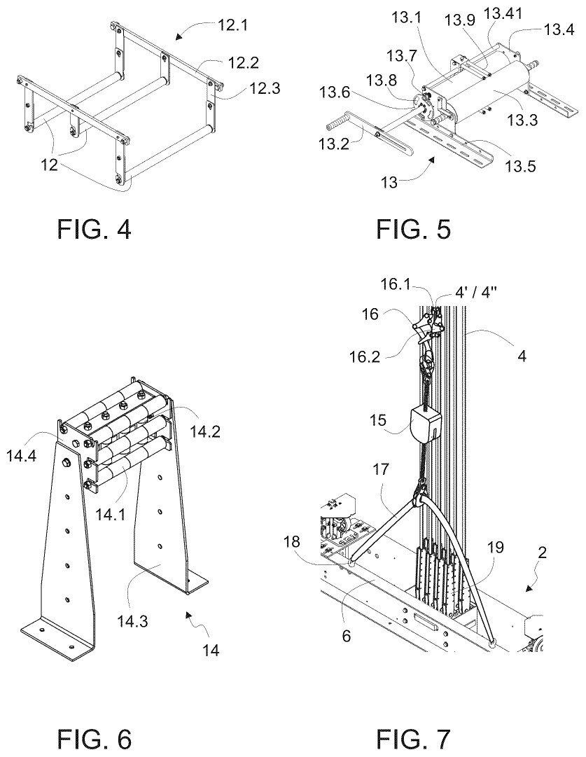

In FIG. 4 the friction reduction rollers 12 are arranged in connection with the traction sheave 8, forming a tool for friction reduction with a roller holder frame 12.1. The roller holder frame 12.1 comprises fixing brackets 12.2 and roller holding brackets 12.3 attached to the fixing brackets. The friction reduction rollers 12 are assembled at their ends rotatably and detachably to the roller holding brackets 12.3. In use, the roller holder frame 12.1 is fixed to the machine 3 frame for example above the traction sheave 8. The rollers 12 may be detached from the frame 12.1 and attached in place to the frame 12 under the rope 4′ or 4″ when the rope 4′ or 4″ is lifted from the traction sheave, i.e., between the suspension rope 4′ or 4″ and the traction sheave 8.

According to an embodiment a low friction coating is applied to the traction sheave 8 and/or the diverting pulley 9 to make it easier to slide the rope over the sheave 8/pulley 9. The low friction coating may be a PTFE tape or a Velcro band.

FIG. 5 illustrates the rope reeling device 13 in more detail. The rope reeling device 13 comprises a friction roller 13.1 which is manually operable by a crank assembly 13.2, and a detachable idler roller 13.3. The friction roller 13.1 and the idler roller 13.3 are installed in use so that a suitable clearance is formed therebetween for the rope to be replaced. The rope reeling device 13 comprises a device frame 13.4 with side walls for receiving and fixing rotatably the friction roller 13.1 and the idler roller 13.3. The side walls may be fixed to fixing brackets 13.5 for attaching the rope reeling device 13 onto the machine 3 bed plate so that the rope 4 can be guided over the idler roller 13.3. The idler roller 13.3 may be detached from the device frame 13.4 and locked in place to the device frame 13.4 under the rope 4′ or 4″ when the rope 4′ or 4″ is lifted from the diverting pulley 9, i.e., between the suspension rope 4′ or 4″ and the diverting pulley 9.

The rope reeling device 13 may comprise blocking members, such as a blocking disk 13.6 fixed to the crank assembly 13.2 and receiving a blocking pin 13.7 in the side wall of the device frame 13.4 which may be spring loaded, to prevent the crank 13.2 and the friction roller 13.1 from turning and thus the rope 4 from moving. The blocking pin may be locked in place by a locking pin to avoid the spring to push the blocking pin into a slot 13.8 in the blocking disk.

The rope reeling device 13 may comprise rope guides 13.9 which may be tightened to a support bar 13.41 connecting the side walls of the device frame 13.4 to prevent the ropes from moving sideways.

FIG. 6 illustrates the rope guidance tool 14 in more detail. The rope guidance tool 14 may be placed onto a landing 31, 32 and secured with screws.

In an example installed position, the rope guidance tool 14 comprises horizontal first rollers 14.1 and vertical second rollers 14.2 secured rotatably relative base legs 14.3 to be fixed stationary. The rotational axes of the first rollers 14.1 extend horizontally between the base legs 14.3. The first rollers 14.1 may form linear rows. The rows of first rollers 14.1 may be detachably fixed between end walls 14.4, which may be connected adjustably to the base legs 14.3. According to an embodiment the end walls 14.4 are connected height adjustably to the base legs 14.3. According to an embodiment the end walls 14.4 are connected angle adjustably to the base legs 14.3. There may be at least two rows of first rollers 14.1 located in different vertical positions between the end walls 14.4. The vertical rollers 14.2 are located between rows of horizontal rows of first rollers 14.1. The rotational axes of the first and second rollers are perpendicular to each other.

In FIG. 7 the tools for holding and elongating the rope 4′ or 4″ during removing and installing comprise a hoist 15 and a rope gripper 16 installed between one suspension rope 4′ or 4″ and the car 2. The hoist 15 may be a manual chain hoist as shown in FIG. 7 or a motor driven chain hoist. The rope gripper 16 may comprise compressible jaws 16.1 for holding the rope 4′ or 4″. The rope gripper 16 may comprise a side stopper plate 16.2 to prevent the rope 4′ or 4″ from getting out between the jaws 16.1. The hoist 15 may be connected at a first end to the gripper 16 and at a second end to a lifting strap 17 connected to the car 2 frame 6 such as a sling top beam. The lifting strap 17 may be connected via shackles to lifting eyes 18 in the frame 6.

The gripper 16 may be fixed to about 1.5 m above a rope terminal 19 of the rope 4″ to be removed or the rope 4′ to be installed, and the side stopper plate 16.2 moved to position to prevent the rope from getting out between the jaws.

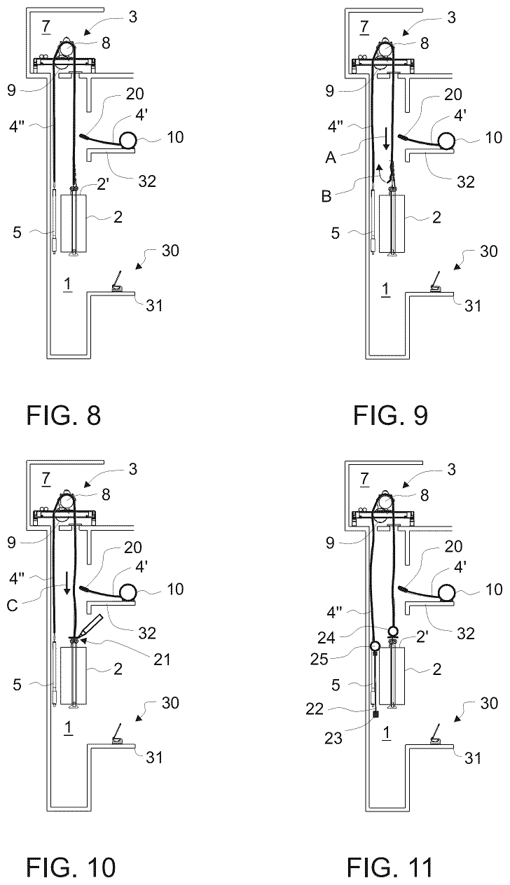

The suspension rope replacement is further described hereinafter with help of FIGS. 8 to 17 illustrating different phases of the replacement method in the arrangement 100.

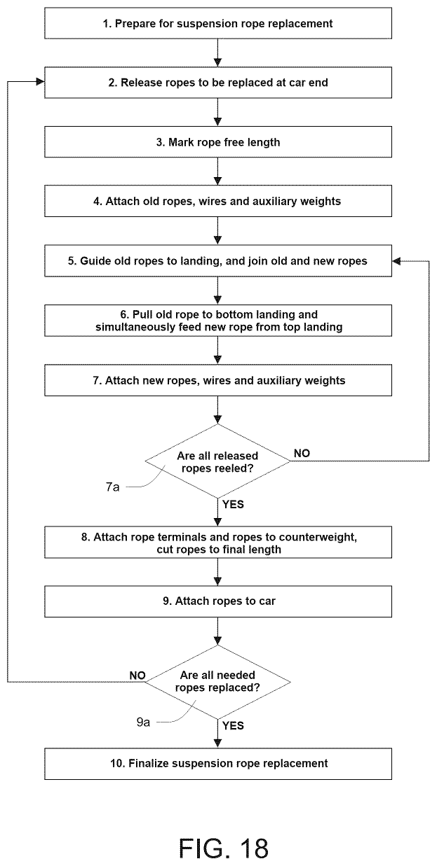

FIG. 18 shows example steps of the elevator suspension rope replacement method numbered from phase 1 to phase 10 in a flow chart. The sequence described in FIG. 18 may be used also if more than one rope is to be replaced at the same time. The sequence of steps shown in FIG. 18 is in no way intended to be binding but rather as a describing example.

FIG. 8 illustrates preparations which may be made for suspension rope replacement (step 1 in FIG. 18). The rope reel or reels 10 with new rope 4′ may be provided to the topmost landing 32, for example using a pallet truck or site trolley, and said reel 10 is prepared in correct position for reeling out or unwinding the new rope 4′. Optionally at least one new rope reel may be provided on the car roof 2′ or inside the car 2 (not show in the Figures).

The outstanding first end of the new rope 4′ may be prepared for joining with the old rope 4″, for example by providing a joining member 20 for said first end of the new rope 4′. The joining member 20 preferably comprises a mesh grip 20 or a corresponding joining member suitable for joining ends of suspension ropes together. The mesh grip 20 may be tube-like or sleeve-like. The mesh grip 20 may be secured on the rope 4′ first end e.g. with tape.

Rope guidance tools 14 may be installed to the landings 31, 32 or the elevator shaft 1 as shown in FIG. 1.

The machinery 3 and the machine room 7 may be prepared so that the ropes are accessible, for example covers, shields and equipment in an inconvenient location may be removed temporarily.

The rope cutter 30 may be provided on the bottommost landing 31 and positioned so that the ropes can be routed correctly. Optionally at least one empty rope reel may be provided on the bottommost landing 31 and positioned so that the ropes can be routed correctly.

The car roof 2′ and the counterweight 5 may be prepared so that rope ends and rope terminals are accessible for rope replacement. Optionally at least one empty rope reel may be provided on the car roof 2′ or inside the car 2 (not show in the Figures).

During preparation of the counterweight side of the rope, the car 2 may be moved e.g. using inspection drive so that the counterweight 5 rope terminals are accessible from the car roof 2′.

FIG. 9 illustrates releasing one or more old ropes 4″ to be replaced at car 2 end (step 2 in FIG. 18).

According to an embodiment the one or more ropes 4″ are released one rope at a time.

According to an embodiment the one or more ropes are replaced one rope at a time.

According to an embodiment the number of ropes that are simultaneously released at the car end may vary for example depending on the total number of ropes suspending the car 2.

Preferably old ropes 4″ are released one rope at a time and removed completely from car end before moving on to the next one as described hereinafter. The old rope 4″ to be replaced may be elongated and held in place as shown with arrow A, for example using the tools 15, 16, 17, 18 for elongating and holding the rope as shown in FIG. 7. The old rope 4″ may be pulled down using the hoist 15 in a first direction until the rope terminal 19 spring is loose. Thereafter, the rope terminal 19 may be released from the car 2 as shown with arrow B, and tension may be released from the rope by using the hoist 15 in a reverse second direction.

According to an embodiment the rope terminal 19 at car end is removed when the car 2 is in halfway position in the shaft 1. When releasing the rope terminal, the weight balance of the rope to be released on both sides of the traction sheave 8 does not move substantially said rope.

FIG. 10 illustrates marking the tension free length 21 of the released old rope 4″ at car 2 side (step 3 in FIG. 18). Tension from the counterweight side rope may be released, the rope lifted on the traction sheave 8 and the diverting pulley 9, and all the slack moved to the car side of the traction sheave as shown with arrow C. The rope cutting length 21 may be marked to the rope terminal 19 of an adjacent rope or an adjacent rope 4 on car side. The old rope length may be seen from the bottom of the rope terminal 19.

FIG. 11 illustrates attaching old ropes 4″ and providing guiding wires 22 and auxiliary weights 23 (step 4 in FIG. 18). The rope 4″ end 24 on the car side may be secured. The counterweight rope terminal may be detached from the counterweight 5.

According to an embodiment the counterweight 5 rope terminal is removed when the car 2 is in a position in the shaft 1 that allows access to the counterweight rope terminals from the roof 2′ of the car 2.

The guiding wire 22 may be fixed to the rope 4″, for example via the counterweight rope terminal, at the rope other end 25. The auxiliary weight 23 may be attached to the end of the wire 22. The counterweight rope terminals may be fixed temporarily to the counterweight frame or adjacent terminal for example using magnets.

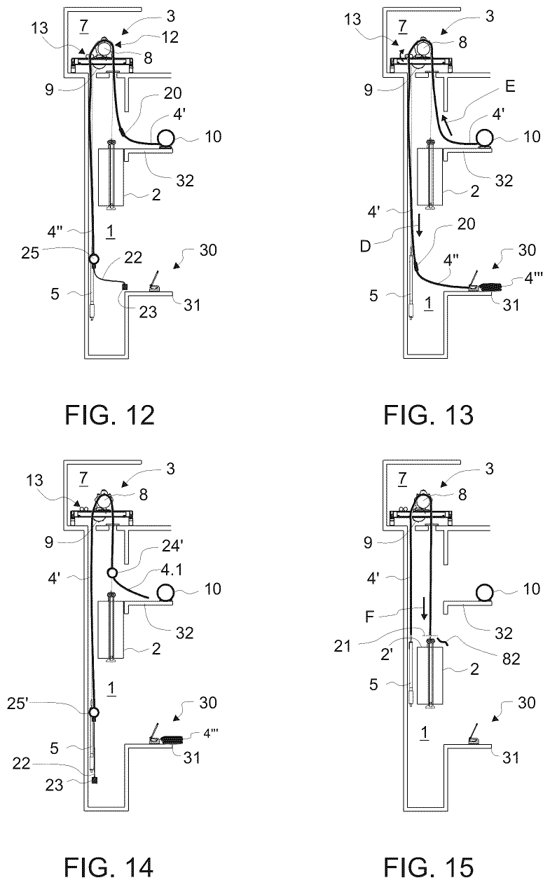

FIG. 12 illustrates guiding the one or more old rope 4″ to the landing, preferably to the bottommost landing 31, and joining old 4″ and new ropes 4′ (step 5 in FIG. 18). Multiple ropes may be removed simultaneously, but reeling may be done one rope at a time.

Optionally a low friction coating may be applied to the traction sheave 8 and/or diverting pulley 9 to make it easier to slide the rope over the sheave 8/pulley 9.

The car 2 may be moved to the topmost landing 32 for joining old and new ropes. The car 2 may be moved using car roof inspection drive.

The new rope 4′ may be guided through the rope guidance tool 14 placed on the landing 32 as shown in FIG. 1. The new rope 4′ end may be pulled to the elevator car roof 2′, where the old rope 4″ may be cut near the rope terminal 19 housing and the old terminal may be discarded.

The new rope 4′ may be connected end to end to the old rope 4″ with the mesh grip 20. The ends of the ropes 4′, 4″ may be inserted into the tubular mesh grip 20. The ends of the ropes may be secured with the mesh grip 20 with a predetermined inserting length e.g. 400 mm for both ropes, preferably ensuring that there is no gap between rope ends.

The reeling device 13 with friction roller 13.1 may be fixed in place, preferably so that prepared fixings in the machine bed can be used for fixing, and prepared operational. The friction roller 13.1 may be blocked to prevent the ropes from moving. Slack over the traction sheave 8 may be pulled so that the idler roller 13.3 can be installed into the reeling device 13 and under the rope that is being replaced.

The friction reduction rollers 12 may be fixed to the machine frame for example as described in connection with FIG. 4.

The twist stopper tool 11 may be placed on the machine bed plate on car side of the traction sheave 8 and secured with clamps.

The old rope 4″ may be guided to the landing 31 by catching the wire 22 from the landing 31 and pulling the wire 22 with the auxiliary weight 23. According to an embodiment the catching of the wire is done using the catcher tool.

FIG. 13 illustrates pulling the old rope 4″ to the bottom landing 31 as shown by arrow D, and simultaneously feeding new rope 4′ from the top landing 32 as shown by arrow E (step 6 in FIG. 18).

The old rope 4″ may be replaced with the new rope 4′ by rotating the reeling device 13 to move the ropes 4″,4′ until the rope joint shown with the mesh grip 20 reaches the bottom landing 31. The reeling device 13 may be used and the rope may be guided over the traction sheave 8. At the top landing 32 the new rope 4′ reel 10 may be rotated. At the bottom landing 31 the old rope 4″ may be cut into pieces.

The end of the rope 4″ may be guided to the cutter 30 on the landing 31, and the counterweight rope terminal, wire 22 and magnets may be removed from the end of the rope by cutting the rope end.

The old rope 4″ may be guided to the landing 31, preferably through the rope guidance tool 14 fixed on the landing 31, as shown in FIG. 1. Simultaneously new rope 4′ may be fed from the top landing 32. The old rope 4″ may be cut into rope pieces 4″ by the cutter 30.

FIG. 14 illustrates attaching the new rope 4′, and attaching the wire 22 and the auxiliary weight 23 for rope tensioning to the one or more new ropes 4′ (step 7 in FIG. 18).

At the bottommost landing 31 the magnets in the end 25′ of the new rope may be attached with tape. The wire 22 and the tension weight 23 may be attached in the end of the new rope 4′. The end 25′ of the rope 4′ may be brought near the counterweight 5 frame, for example until magnets attach said frame. According to an embodiment said bringing of the rope is done using the catcher tool, preferably without visiting the shaft.

At the top landing 32 the new rope 4′ may be attached at 24′ reliably to an adjacent rope for example using tape. The new rope 4′ may be cut, leaving preferably a predetermined minimum length, for example minimum 1 m extra tail 4.1 to the rope.

In the machine room 7, the friction reduction rollers 12 may be removed. The rope 4′ may be removed from between the reeling device 13 rollers.

The low friction coating may be removed from the traction sheave 8 and/or the diverting pulley 9, if previously applied.

If there are more ropes to be reeled (reference sign 7a in FIG. 18), with joining a further old 4″ and a further new rope 4′ may be continued (again step 5 in FIG. 18). If all ropes have been reeled, the roller holder frame 12.1, the reeling device 13 and the twist stopper tool 11 may be removed.

FIG. 15 illustrates attaching the one or more rope terminal with the new rope 4′ to the counterweight 5 and cutting the rope to final length (step 8 in FIG. 18).

According to an embodiment the counterweight 5 rope terminal is secured when the car 2 is in a position in the shaft 1 that allows access to the counterweight rope terminals from the roof 2′ of the car 2.

The car 2 may be moved to the midpoint of the shaft 1, thus providing access from car 2 roof to the counterweight hitch plate and to the fixing point of the counterweight side rope terminal when attaching the rope terminal and the new rope 4′ to the counterweight 5. The car roof inspection drive may be used to move the car. The rope position on the traction sheave 8 may be monitored during driving the machinery 3 and moving the car 2.

The rope terminal may be fixed on the new rope 4′ on the counterweight side, and the terminal may be attached on the counterweight 5.

The slack in the new rope 4′ may be moved on car side of the traction sheave 8 as shown in by arrow F. The new rope 4′ may be cut a short offset, for example approximately 15 mm, above the length mark 21 based on the tension free rope length of the old rope 4″ at the car roof. This offset compensates a terminal wedge movement when the rope is tightened. The rope terminal 19 may be fixed on the new rope 4′ on the car side.

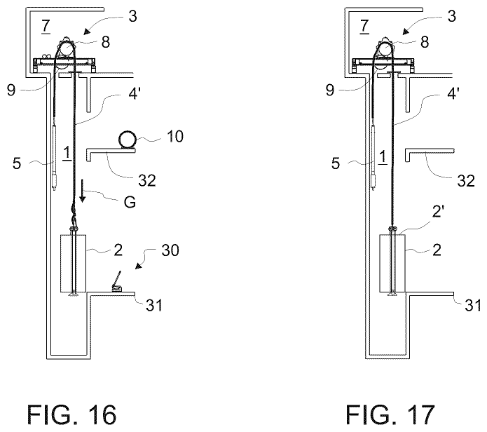

FIG. 16 illustrates attaching one or more ropes to the car 2 (step 9 in FIG. 18). The rope terminal 19 (shown in FIG. 7) may be fixed to the car 2 hitch plate. The car 2 may be moved to the bottommost landing 31 using the car roof inspection drive.

According to an embodiment the rope terminal 19 at car end is secured in place when the car 2 is in a bottom position in the shaft 1. Then almost the entire length of the stretching rope is on the side of the car 2, and it is easier to elongate the rope into place.

The new rope 4′ to be attached may be elongated and held in place as shown with arrow G, for example using the tools 15, 16, 17, 18 for elongating and holding the rope as shown in FIG. 7. The new rope 4′ may be pulled down with the hoist 15 so that the rope terminal 19 can be connected to the car 2, preferably by installing rope fixing spring and eye bolt nuts, and the rope elongation arrangement may be dismantled. The elongating and attaching step may be repeated to each released rope.

If more ropes need to be replaced (reference sign 7a in FIG. 18), repeat the replacement procedure starting from releasing one or more old ropes at car end (step 2 in FIG. 18).

FIG. 17 illustrates finalizing the suspension rope replacement (step 10 in FIG. 18). The machinery 3 and elevator operation may be prepared, tested and finalized for operational use of the elevator, for example machine covers may be installed. Protective material from the machine room 7 may be removed. The rope tensions may be adjusted and the car roof 2′ prepared for operational use of the elevator.

According to an embodiment the rope to be replaced has a rectangular cross section. According to an embodiment the rope to be replaced has a circular cross section.

According to an embodiment the rope to be replaced comprises a steel rope. According to an embodiment the rope to be replaced comprises a coating. According to an embodiment the rope to be replaced comprises a construction of carbon fiber reinforced polymer (CFRP) bars which are covered in thermoplastic polyurethane (TPU). According to an embodiment the rope to be replaced has a width larger than its thickness in a transverse direction of the rope, and comprises a load-bearing part made of a composite material, said composite material comprising reinforcing fibers, which consist of carbon fiber or glass fiber, in a polymer matrix.

The method may also be partially applied to other maintenance work that requires the rope 4 to be slackened.

For example, the springs on the rope terminals can be replaced conveniently one at a time without having to park the car 2. Parking the car is a time-consuming job.

Further, a rope 4 may be turned around if the rope coating on the traction sheave 8 side is damaged.

According to an embodiment replacement of an individual suspension rope may be implemented if the ropes characteristics do not change in use, for example there will not occur permanent elongation of the rope, or the ropes stiffness does not change, or the coating of the rope does not wear.

It will be obvious to a person skilled in the art that, as the technology advances, the inventive concept can be implemented in various ways. The invention and its embodiments are not limited to the examples described above but may vary within the scope of the claims.

1. An arrangement for replacing one or more elevator suspension ropes, the arrangement comprising an elevator shaft; and
an elevator with a car, a hoisting machinery, one or more suspension ropes, and a counterweight;
the car and the counterweight being suspended by said one or more ropes which are adapted to be guided over a traction sheave comprised by the machinery for moving the car along the elevator shaft;
wherein
the car and the counterweight are arranged at any vertical height in the shaft when replacing said one or more ropes.

2. The arrangement according to claim 1, wherein the car is arranged to be movable during the one or more rope replacement, and/or
wherein the one or more ropes are adapted to be released one rope at a time.

3. The arrangement according to claim 1, comprising at least one reel for new rope arranged on a topmost landing of the shaft or on the car roof or inside the car for new rope delivering.

4. The arrangement according to claim 1, comprising a cutter or at least one reel for old rope arranged on a bottommost landing of the shaft for old rope treatment, and/or
comprising tools for holding and elongating the rope during removing and installing the rope, comprising a hoist and a rope gripper to be installed between one suspension rope and the car, and/or
comprising a rope reeling device with a friction roller arranged in connection with the machinery for forming a tool for moving the rope to be replaced, and/or
wherein friction reduction rollers are arranged in connection with the traction sheave for forming a tool for friction reduction, and/or
wherein a twist stopper tool is placed in the path of the rope, and/or
wherein a rope guidance tool is arranged on the topmost landing and/or on the bottommost landing of the shaft for guiding the ropes, and/or
wherein a rope storage unit with at least one rope reel is arranged on the topmost landing and/or on the bottommost landing of the shaft for storing and reeling the ropes, and/or
wherein the car is arranged to be moved using inspection drive at any stage of the rope replacement.

5. The arrangement according to claim 1, wherein an end of the old rope is adapted to be taken from the counterweight to the bottommost landing of the shaft and the new rope is adapted to be moved from the landing to the counterweight without a technician visiting the shaft.

6. The arrangement according to claim 1, wherein the one or more ropes are adapted to be replaced one rope at a time, and/or
wherein one or more ropes are simultaneously adapted to be released at the car end, and/or
wherein a low friction coating is adapted to be applied on the traction sheave and/or the diverting pulley, and/or
wherein a rope terminal at the car end is adapted to be removed when the car is in halfway position in the shaft, and/or
wherein a counterweight rope terminal is adapted to be removed when the car is in a position in the shaft that allows access to the counterweight rope terminals from a roof of the car, and/or
wherein the car is adapted to be moved to the topmost landing in the shaft for joining old and new ropes.

7. The arrangement according to claim 1, wherein the old rope is adapted to be guided to the bottommost landing of the shaft, and simultaneously the new rope is adapted to be fed from the topmost landing.

8. The arrangement according to claim 1, wherein a counterweight rope terminal is adapted to be secured to the counterweight when the car is in a position in the shaft that allows access to the counterweight rope terminals from a roof of the car.

9. The arrangement according to claim 1, wherein the rope to be replaced comprises a load-bearing part made of a composite material, said composite material comprising reinforcing fibers, which consist of carbon fiber or glass fiber, in a polymer matrix.

10. A method for replacing one or more elevator suspension ropes in an arrangement according to claim 1, comprising
arranging the car and the counterweight at any vertical height in the shaft when replacing said one or more ropes.

11. The method according to claim 10, comprising arranging at least one reel for new rope on a topmost landing of the shaft or on the car roof or inside the car for new rope delivering, and/or
comprising arranging a cutter or at least one reel for old rope on a bottommost landing of the shaft for old rope treatment, and/or
comprising holding and elongating the rope during removing and installing by a hoist and a rope gripper installed between one suspension rope and the car, and/or
comprising moving the rope to be replaced by a rope reeling device with a friction roller in connection with the machinery, and/or
comprising reducing friction by friction reduction rollers arranged in connection with the traction sheave, and/or
comprising placing a twist stopper tool in the path of the rope, and/or
comprising guiding the ropes by a rope guidance tool which is arranged on the topmost landing and/or on the bottommost landing of the shaft, and/or
comprising storing and reeling the ropes by a rope storage unit with at least one rope reel arranged on the topmost landing and/or on the bottommost landing of the shaft, and/or
comprising moving the car using inspection drive at any stage of the rope replacement.

12. The method according to claim 10, comprising taking an end of the old rope from the counterweight to the bottommost landing and moving the new rope from the landing to the counterweight without a technician visiting the shaft.

13. The method according to claim 10, comprising replacing the one or more suspension ropes one rope at a time, and/or
comprising removing a rope terminal at the car end when the car is in halfway position in the shaft, and/or
comprising removing a counterweight rope terminal when the car is in a position in the shaft that allows access to the counterweight rope terminals from a roof of the car, and/or
comprising moving the car to the topmost landing in the shaft for joining old and new ropes.

14. The method according to claim 10, comprising guiding the old rope to the bottommost landing of the shaft, and simultaneously feeding the new rope from the topmost landing.

15. The method according to claim 10, comprising securing a counterweight rope terminal to the counterweight when the car is in a position in the shaft that allows access to the counterweight rope terminals from a roof of the car.
